(19) United States
(12) Patent Application Publication
(10) Pub. No.: US 2013/0179467 A1
(43) Pub. Date: Jul. 11, 2013

(54) Calculating Property Caching Exclusions In A Graph Evaluation Query Language

(71) Applicant: Google Inc., Mountain View, CA (US)

(72) Inventor: Joshua D. Ain, Somerville, MA (US)

(73) Assignee: Google Inc., Mountain View, CA (US)

(21) Appl. No.: 13/723,426

(22) Filed: Dec. 21, 2012

Related U.S. Application Data
(60) Provisional application No. 61/585,397, filed on Jan. 11, 2012.

(51) Int. Cl. G06F 17/30

(52) U.S. Cl. CPC G06F 17/30979
USPC 707/771

(57) ABSTRACT

The present disclosure involves methods, systems, and apparatus, including computer programs encoded on computer storage media, for calculating property caching exclusions in a graph evaluation query language. One method includes determining whether a value of a query property operation corresponds to a named sub-query, using a first cache to determine whether the named sub-query uses labels, parsing the named sub-query into a first parse tree, and evaluating, by operation of a computer, the parsed named sub-query using the first parse tree to determine whether the result for the named sub-query may be cached, the evaluation comprising: determining whether a node operation is encountered in the named sub-query, determining whether a value of a named sub-query property operation corresponds to a new named sub-query, using a first cache to determine whether the new named sub-query uses labels, parsing the new named sub-query into a second parse tree, and evaluating the parsed new named sub-query using the second parse tree to determine whether the result for the new named sub-query may be cached.

### CLAIM OF PRIORITY

This Application claims priority under 35 U.S.C. §119(e) to U.S. Provisional Patent Application Ser. No. 61/585,397, filed on Jan. 11, 2012. The entire contents of U.S. Provisional Patent Application Ser. No. 61/585,397, are hereby incorporated by reference.

### BACKGROUND

This specification relates to caching database query results in a graph evaluation query language. A database query in a graph evaluation query language is used for data exploration and/or analysis of a database and may contain references to sub-queries or to variables. Efficient caching of database query results, where the query contains references to sub-queries or variables, enhances the performance and efficiency of processing the database query.

### SUMMARY

A method is described for determining whether a value of a database query property operation may be cached. A determination is made whether the value corresponds to a named sub-query and whether a first cache indicates the named sub-query uses labels. The named sub-query is parsed and evaluated to determine whether the result of the named sub-query is cacheable. The evaluation of the named sub-query includes determining whether a node operation is encountered in the parsed named sub-query and determining whether a value of a named sub-query property operation corresponds to a new named sub-query. A determination is made whether the first cache indicates the new named sub-query uses labels. The new named sub-query is also parsed and evaluated similar to that of the named sub-query.

In general, one innovative aspect of the subject matter described in this specification can be embodied in methods that include the actions of determining whether a value of a query property operation corresponds to a named sub-query, using a first cache to determine whether the named sub-query uses labels, parsing the named sub-query into a first parse tree, and evaluating, by operation of a computer, the parsed named sub-query using the first parse tree to determine whether the result for the named sub-query may be cached, the evaluation comprising: determining whether a node operation is encountered in the named sub-query, determining whether a value of a named sub-query property operation corresponds to a new named sub-query, using a first cache to determine whether the new named sub-query uses labels, parsing the new named sub-query into a second parse tree, and evaluating the parsed new named sub-query using the second parse tree to determine whether the result for the new named sub-query may be cached.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, and/or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In particular, one embodiment can include all the following features. The value of the query property operation is added to a second cache. The value of the query property operation is used to continue execution of the query. An indication is included in the first cache that the named sub-query uses labels upon the determination that a node operation is encountered in the named sub-query. An indication is included in the first cache that any ancestral query of the named sub-query uses labels. The result of the parsed named sub-query is added to a second cache. The result of the parsed named sub-query is used to continue execution of the query. An indication is included in the first cache that the named sub-query uses labels upon an indication in the first cache that the new named sub-query uses labels. An indication is included in the first cache that any ancestral query of the new named sub-query uses labels.

The subject matter described in this specification can be implemented in particular implementations so as to realize one or more of the following advantages. First, efficient caching of sub-queries increases performance of the database and ensures the accuracy of query results. Second, higher efficiency results in a more cost-effective database system. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example environment for supporting calculating property caching exclusions in a graph evaluation query language in accordance with one implementation of the present disclosure.

FIG. 2. illustrates an example parse tree illustrated as a thread topology diagram.

FIGS. 3A-3B are flowcharts illustrating an example method for calculating property caching exclusions in a graph evaluation query language.

Like reference numbers and designations in the various drawings indicate like elements.

### DETAILED DESCRIPTION

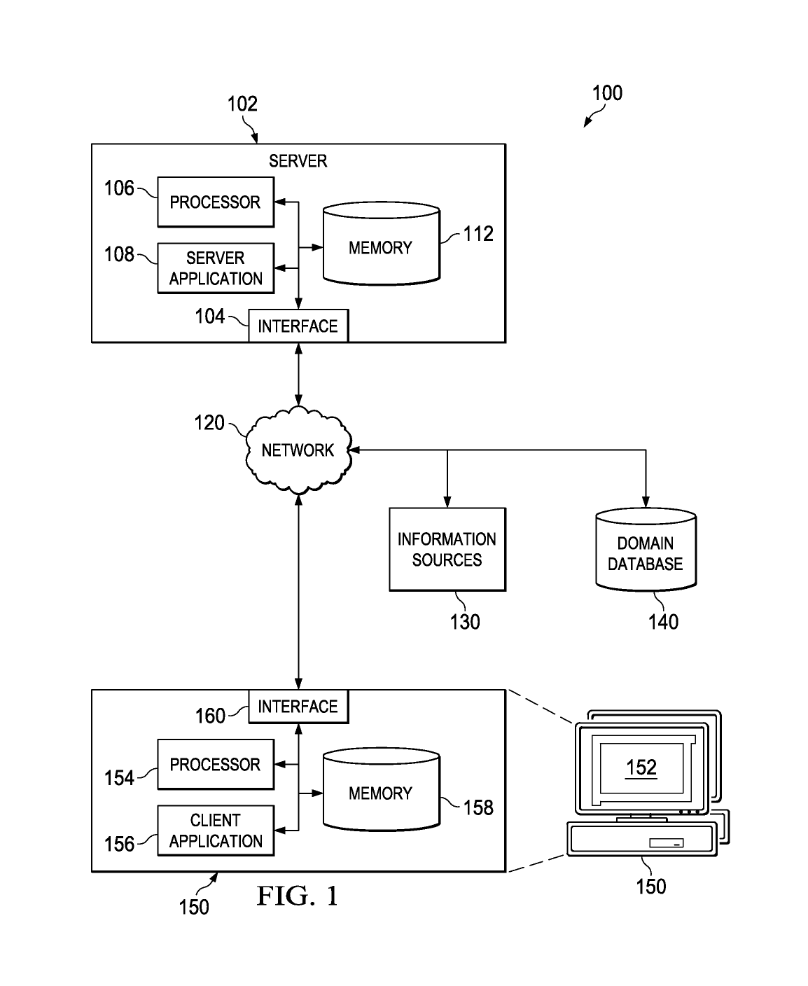

Turning to the figures, FIG. 1 illustrates an example environment 100 for supporting calculating property caching exclusions in a graph evaluation query language in accordance with one implementation of the present disclosure. The illustrated environment 100 includes, or is communicably coupled with, a server 102, a network 120, at least one information source 130, and a client 150. A client 150 and server 102 are generally remote from each other and typically interact through the network 120. The relationship of client and server arises by virtue of computer programs running on the respective computers and having a client-server relationship to each other.

The server 102, the at least one information source 130, and the client 150 may communicate across or via network 120. In alternative implementations, the elements illustrated within the server 102, the at least one information source 130, and the client 150 can be included in or associated with different and/or additional servers, clients, networks, or locations other than those illustrated in FIG. 1. Additionally, the functionality associated with any component illustrated in example environment 100 may be associated with any suitable system, including by adding additional computer programs to existing systems. For example, the components illustrated within the server 102 may be included in multiple servers, cloud-based networks, or other locations accessible, either directly or via network 120, to the server 102.

In general, the server 102 is any server that provides support to the client 150 for calculating property caching exclusions in a graph evaluation query language. In some implementations, the server can also provide support to the client 150 using at least a server application 108 interacting with a domain database 140. Although FIG. 1 illustrates a single server 102, example environment 100 can be implemented using any number of servers.

For example, each server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some implementations, other non-Java based servers and/or systems could be used for the server 102. In some implementations, each server 102 can store and execute a plurality of various other applications (not illustrated), while in other implementations, each server 102 can be a dedicated server meant to store and execute a particular server application 108 and related functionality. In some implementations, the server 102 can comprise a Web server or be communicably coupled with a Web server, where the particular server application 108 associated with that server 102 represents a Web-based (or Web-accessible) application accessed and executed on an associated client 150 to perform the programmed tasks or operations of the corresponding server application 108. In still other instances, the server application 108 can be executed on a first system, while the server application 108 manipulates and/or provides information for data located at a remote, second system (not illustrated).

At a high level, the server 102 comprises an electronic computing device operable to receive, transmit, process, store, or manage data and information associated with the example environment 100. The server 102 illustrated in FIG. 1 can be responsible for receiving application requests from a client 150 (as well as any other entity or system interacting with the server 102), responding to the received requests by processing said requests in an associated server application 108 and sending the appropriate responses from the server application 108 back to the requesting client 150 or other requesting system. The server application 108 can also process and respond to local requests from a user locally accessing the associated server 102. Accordingly, in addition to requests from the external clients 150 illustrated in FIG. 1, requests associated with a particular server application 108 may also be sent from internal users, external or third-party customers, as well as any other appropriate entities, individuals, systems, or computers. In some implementations, the server application 108 can be a Web-based application executing functionality associated with the networked or cloud-based business process.

In the illustrated implementation of FIG. 1, the server 102 includes an interface 104, a processor 106, a server application 108, and a memory 112. While illustrated as a single component in the example environment 100 of FIG. 1, alternative implementations may illustrate the server 102 as comprising multiple or duplicate parts or portions accordingly.

The interface 104 is used by the server 102 to communicate with other systems in a client-server or other distributed environment (including within example environment 100) connected to the network 120 (e.g., an associated client 150, as well as other systems communicably coupled to the network 120). FIG. 1 depicts both a server-client environment, but could also represent a cloud-computing network. Various other implementations of the illustrated example environment 100 can be provided to allow for increased flexibility in the underlying system, including multiple servers 102 performing or executing at least one additional or alternative implementation of the server application 108, as well as other applications (not illustrated) associated with or related to the server application 108. In those additional or alternative implementations, the different servers 102 can communicate with each other via a cloud-based network or through the connections provided by network 120. Returning to the illustrated example environment 100, the interface 104 generally comprises logic encoded in computer programs and/or hardware in a suitable combination and operable to communicate with the network 120. More specifically, the interface 104 may comprise computer programs supporting at least one communication protocol associated with communications such that the network 120 or the interface's hardware is operable to communicate physical signals within and outside of the illustrated example environment 100.

Generally, the server 102 may be communicably coupled with a network 120 that facilitates wireless or wireline communications between the components of the example environment 100, that is the server 102 and the client 150, as well as with any other local or remote computer, such as additional clients, servers, or other devices communicably coupled to network 120, including those not illustrated in FIG. 1. In the illustrated example environment 100, the network 120 is depicted as a single network, but may be comprised of more than one network without departing from the scope of this disclosure, so long as at least a portion of the network 120 may facilitate communications between senders and recipients. In some implementations, at least one component associated with the server 102 can be included within the network 120 as at least one cloud-based service or operation. The network 120 may be all or a portion of an enterprise or secured network, while in another implementation, at least a portion of the network 120 may represent a connection to the Internet. In some implementations, a portion of the network 120 can be a virtual private network (VPN). Further, all or a portion of the network 120 can comprise either a wireline or wireless link. Example wireless links may include cellular, 802.11a/b/g/n, 802.20, WiMax, and/or any other appropriate wireless link. In other words, the network 120 encompasses any internal or external network, networks, sub-network, or combination thereof operable to facilitate communications between various computing components inside and outside the illustrated example environment 100. The network 120 may communicate, for example, Internet Protocol (IP) packets, Frame Relay frames, Asynchronous Transfer Mode (ATM) cells, voice, video, data, and other suitable information between network addresses. The network 120 may also include at least one local area network (LAN), radio access network (RAN), metropolitan area network (MAN), wide area network (WAN), all or a portion of the Internet, and/or any other communication system or systems in at least one location. The network 120, however, is not a required component in some implementations of the present disclosure.

As illustrated in FIG. 1, the server 102 includes a processor 106. Although illustrated as a single processor 106 in the server 102, two or more processors may be used in the server 102 according to particular needs, desires, or particular implementations of example environment 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the server 102 and, specifically, the functionality associated with the corresponding server application 108. In one implementation, the server 102 processor 106 executes the functionality required to also receive and respond to requests and instructions from the client 150. In the illustrated example environment 100, each processor 106 executes the server application 108 stored on the associated server 102. In other implementations, a particular server 102 can be associated with the execution of two or more server applications 108 as well as at least one distributed application (not illustrated) executing across two or more servers 102.

A server application 108 is illustrated within the server 102 and may operate to execute database-related actions. Although illustrated as a single server application 108 in the server 102, two or more server applications 108 may be used in the server 102 according to particular needs, desires, or particular implementations of example environment 100. The server application 108 can be any application, module, process, or other computer programs that may execute, change, delete, generate, or otherwise manage information associated with a particular server 102, particularly with respect to supporting calculating property caching exclusions in a graph evaluation query language. In some implementations, a particular server application 108 can operate in response to and in connection with at least one request received from an associated client 150. Additionally, a particular server application 108 may operate in response to and in connection with at least one request received from other server applications 108, including a server application 108 associated with another server 102. In some implementations, each server application 108 can represent a Web-based application accessed and executed by remote clients 150 via the network 120 (e.g., through the Internet, or via at least one cloud-based service associated with the server application 108). For example, a portion of a particular server application 108 may be a Web service associated with the server application 108 that is remotely called, while another portion of the server application 108 may be an interface object or agent bundled for processing at a remote client 150. Moreover, any or all of a particular server application 108 may be a child or sub-module of another computer program (not illustrated) without departing from the scope of this disclosure. Still further, all or a portion of the particular server application 108 may be executed or accessed by a user working directly at the server 102, as well as remotely at a corresponding client 150.

The server 102 also includes a memory 112 for storing data and program instructions. The memory 112 may include any memory or database module and may take the form of volatile or non-volatile memory including, without limitation, magnetic media, optical media, random access memory (RAM), read-only memory (ROM), flash memory, removable media, or any other suitable local or remote memory component. The memory 112 may store various objects or data, including classes, widgets, frameworks, applications, backup data, business objects, jobs, Web pages, Web page templates, database tables, process contexts, repositories storing services local to the server 102, caches, and any other appropriate information including any parameters, variables, database queries, algorithms, instructions, rules, constraints, or references thereto associated with the purposes of the server 102 and an associated server application 108. In some implementations, including a cloud-based system, some or all of the memory 112 can be stored remote from the server 102, and communicably coupled to the server 102 for usage.

The at least one information source 130 may comprise one or more of: computer files containing data in a format such as HTML, PDF, Word, XML, RDF, JSON, CSV, spreadsheet or text; inputs and outputs of network data services such as HTTP, REST, and WSDL, any structured data feed such as XML, CSV, etc., and inputs and outputs of database query languages such as SQL and SPARQL. The at least one information source 130 may correspond to a network accessible data source, including an Internet website, web service feed, or any other suitable information source. Although illustrated as external to server 102 and client 150, the at least one information source 130 may be incorporated into the server 102 and/or client 150 without departing from the scope of this disclosure as long as content from the at least one information source 130 is available to some or all of the elements of example environment 100 via at least network 120.

The at least one domain database 140 is an organized, structured collection of related data used for one or more purposes. In some implementations, the at least one domain database 140 can be configured as a graph database and the at least one database 140 domain model may define properties of graph nodes and relationships between the graph nodes. In some implementations, the graph nodes and relationships can also be represented as resource description framework (RDF) triples or similar semantic representations of structured data. The at least one domain database 140 may correspond to a network accessible database, including an Internet database or other suitable database. Although illustrated as external to server 102 and client 150, the at least one database 140 may be incorporated into the server 102 and/or client 150 without departing from the scope of this disclosure. In some implementations, the at least one domain database 140 may contain one or more caches associated with the data stored and/or processed in the at least one domain database 140.

In general, a client 150 is any computer device operable to connect or communicate with server 102 using a wireless or wireline connection (i.e., network 120). In particular, the client 150 may be embodied as a mobile or non-mobile computing device. At a high level, each client 150 can include a processor 154, a GUI 152, a client application 156, a memory 158, and an interface 160. In general, the client 150 comprises an electronic computer device operable to receive, transmit, process, and/or store any appropriate data associated with it, a server 102, or other suitable data source.

The GUI 152 of the client 150 is operable to allow the user of the client 150 to interface with at least a portion of the system 100 for any suitable purpose, including to allow a user of the client 150 to interact with at least one client application 156, and the server application 108. In particular, the GUI 152 may provide users of the client 150 with a visualized representation of the client application 156, the server application 108, and other client 150 functionality. The GUI 152 may include a plurality of user interface elements such as interactive fields, pull-down lists, buttons, and other suitable user interface elements operable at the client 150.

In some implementations, processor 154 can be similar to processor 106 of the server 102. In other implementations, the processor 154 may be a processor designed specifically for use in client 150. Further, although illustrated as a single processor 154, the processor 154 may be implemented as multiple processors in the client 150. Regardless of the type and number, the processor 154 executes instructions and manipulates data to perform the operations of the client 150, including operations to receive and process information from the server 102 or other suitable data source, access data within memory 158, execute the client application 156, as well as perform other operations associated with the client 150.

A client application 156 is illustrated within the client 150 and may operate to, among other things, support calculating property caching exclusions in a graph evaluation query language. Although illustrated as a single client application 156 in the client 150, two or more client applications 156 may be used in the client 150 according to particular needs, desires, or particular implementations of example environment 100. The client application 156 can be any computer program that may execute, change, delete, generate, or otherwise manage information associated with a particular client 150. In some implementations, a particular client application 156 can operate in response to and in connection with at least one request received from the client 150. Additionally, a particular client application 156 may operate in response to and in connection with at least one request received from other client applications 156, including a client application 156 associated with another client 150. In some implementations, the client application 156 can use parameters, metadata, and other information received at launch to access data from the server 102. Once a particular client application 156 is launched, a user may interactively process a task, event, or other information associated with the client 150 or the server 102. The client application 156 may retrieve information from one or more servers 102 or one or more clients 150. Further, the client application 156 may access a locally-cached set of client-application-related information (not illustrated) stored on the client 150. In some implementations, each client application 156 can represent a Web-based application accessed and executed by clients 150 or servers 102 via the network 120 (e.g., through the Internet, or via at least one cloud-based service associated with the server application 108). For example, a portion of a particular client application 156 may be a Web service associated with the client application 156 that is remotely called, while another portion of the client application 156 may be an interface object or agent bundled for processing at a remote client 150. Moreover, any or all of a particular client application 156 may be a child or sub-module of another computer program (not illustrated) without departing from the scope of this disclosure. Still further, portions of the particular client application 156 may be executed or accessed by a user working directly at the client 150, as well as remotely at a separate client 150, a server 102, or other computer (not illustrated).

The client 150 also includes a memory 158 for storing data and program instructions. Although illustrated as a single memory 158, the memory 158 may be implemented as multiple memories in the client 150. The memory 158 may include any memory or database module and may take the form of volatile or non-volatile memory including, without limitation, magnetic media, optical media, random access memory (RAM), read-only memory (ROM), flash memory, removable media, or any other suitable local or remote memory component. The memory 158 may store various objects or data, including classes, widgets, frameworks, applications, backup data, business objects, jobs, Web pages, Web page templates, database tables, process contexts, repositories storing services local to the client 150, and any other appropriate information including any parameters, variables, database queries, algorithms, instructions, rules, constraints, or references thereto associated with the purposes of the client 150 and an associated client application 156. In some implementations, including a cloud-based system, some or all of the memory 158 can be stored remote from the client 150, and communicably coupled to the client 150 for usage. Although not illustrated, the memory 158 may also store database tables and/or database queries or references to the same similar to analogous counterparts that may be stored in memory 112.

The interface 160 of the client 150 may be similar to the interface 104 of the server 102, in that it may comprise logic encoded in computer programs and/or hardware in a suitable combination and operable to communicate with the network 120. More specifically, interface 160 may comprise computer programs supporting at least one communication protocol such that the network 120 or hardware is operable to communicate physical signals to and from the client 150. Further, although illustrated as a single interface 160, the interface 160 may be implemented as multiple interfaces in the client 150.

While FIG. 1 is described as containing or being associated with a plurality of components, not all components illustrated within the illustrated implementation of FIG. 1 may be utilized in each implementation of the present disclosure. Additionally, at least one component described herein may be located external to example environment 100, while in other implementations, certain components may be included within or as a portion of at least one described component, as well as other components not described. Further, certain components illustrated in FIG. 1 may be combined with other components, as well as used for alternative or additional purposes, in addition to those purposes described herein.

In some implementations, a database query can be written in a graph evaluation query language (“Thread”). In some implementations, the query is written as a string of alphanumeric characters. The Thread query describes a series of graph traversals from some starting set of nodes in a database containing data, each of which results in some new ordered set of nodes, if any, returned as a result. The starting sets of nodes and/or result sets of nodes may be filtered, sorted and/or grouped.

For example, for the following data set stored in the database:

```
    album1
        artist1
            label1
            label2
    album2
        artist2
            label1
            label2
    album3
        artist3
            label1
the query:
    album:(.artist:(.label._count:>1))
```

returns all albums in the database that have artists that each have at least two labels. In this example, the database schema would be album connected to artist, artist connected to both album and label, and label connected to artist. Here the resultant data set would include album1 and album2 since artist1 and artist2, respectively, have at least two labels each. Album3 is not returned as artist3 only has one label, label1. In this example, the colon symbol indicates a filter and the period separates object types and/or object type properties in the query. The query begins with an object type and subsequent object properties are separated from the preceding query by a period character. This example query reads more precisely, return all objects of data type album, filtered by having an artist property whose values have label properties whose total count is greater than one or, more simply, have more than one label property.

In some implementations, Thread may also work with a set of objects of heterogeneous data types. In these implementations, Thread can use “duck typing,” which is using an object's current set of methods and properties to determine its type. Therefore, Thread does not know what data type it is working with in advance of any given point in the Thread query because this determination is made using the object's methods and/or properties at the given point in the Thread query.

In some implementations, prior to executing the query in the above-described example, the query is parsed. In some implementations, parsing translates the query from a string into query operations represented by a parse tree. A parse tree represents the syntactic structure of the query and further describes a hierarchy of children operations. In some implementations, parsing may be performed by a compiler, an interpreter, or any other suitable method. Individual operations, based upon the initial query, may be chained in any order, based, at any length, to assemble complex queries which ultimately return an ordered collection of nodes as a result. In some implementations, the result can be sets or lists. In some implementations, the operations in the parse tree are executed in a depth-first traversal of the parse tree to produce the result.

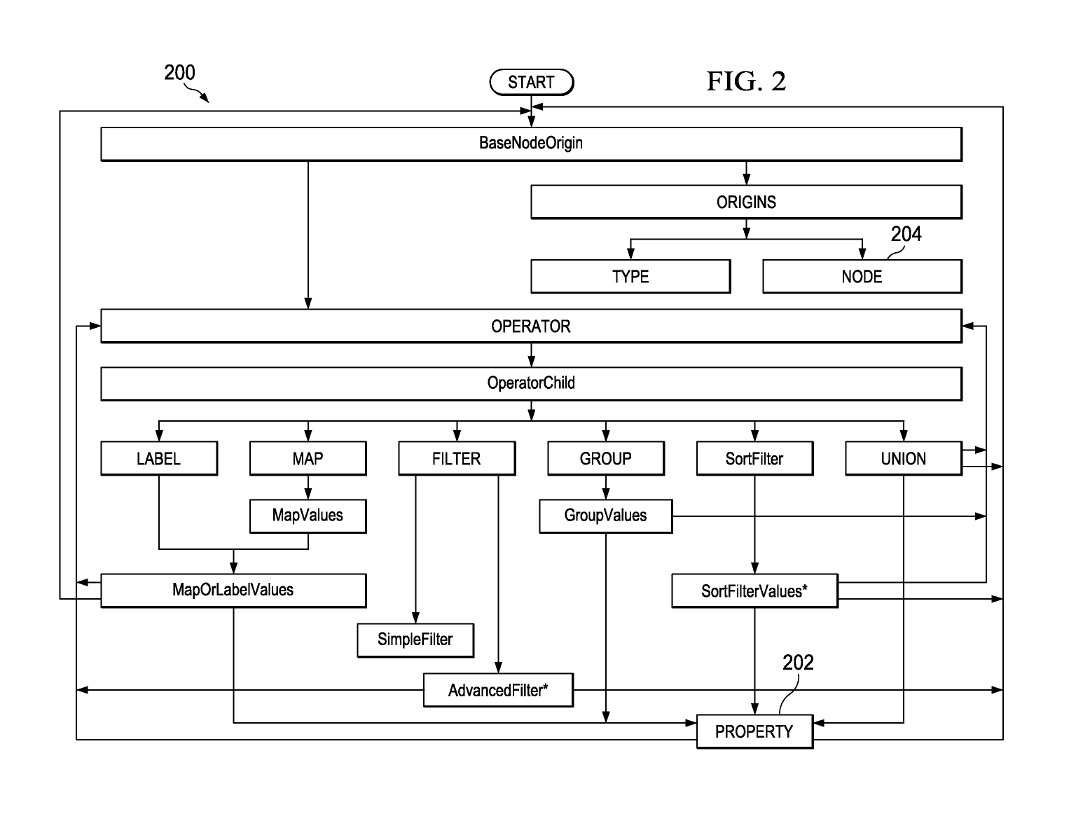

Turning now to FIG. 2, FIG. 2 illustrates a thread topology diagram 200, a description of possible parse trees. In some implementations, for example, operations that may be in a compiled parse tree are illustrated in the thread topology diagram 200. For example, in the thread topology diagram 200, the “Property” operation 202 is represented toward the bottom of the diagram and the “Nodes” operation 204 is represented in the upper right, under the “Origins” operation. Lines between operations indicate the possible children of an operation. In this example, children of the “Start” operation must be of type “BaseNodeOrigin.” Further, “Label,” “Map,” “Filter,” “Group,” “SortFilter,” and “Union” operations are children of an OperatorChild operation which is itself a child of an Operator operation. In some implementations, each operation can be restricted to a single child operation, or each operation can have multiple children operations. The thread topology diagram 200 may be loosely thought of as a finite state machine beginning at “Start.” A specific parse tree will only include specific operations and may include some operations more than once.

Thread allows the definition of named sub-queries, called “columns.” In some implementations, columns are stored in a column store, a persistent data structure that stores columns by both a unique ID and a column name. Columns may be referenced in a Thread query by name.

For example, in the example database above with a schema:

```
album
    artist
        label
```

the album object data type has an innate property to artist, the artist object data type has an innate property to both album and label, and the label object data type has an innate property to the artist object data type. A column named “allLabels” could be defined on the album object data type which would then follow the innate property to the artist object data type and then follow the innate property of the artist object data type to the label object data type. This column could then be referenced by name in any query, and would resolve, at query execution time, to the underlying column. For example, presume that the artist object data type has a defined column called “labelNameFilter.” The column definition may be represented as:
.label:=(@name)

In this case the column labelNameFilter, originating from artist, follows the label property from an artist and then filters the results of that label property to be only those labels that match the content of the previously defined variable “name.”. A Thread query:
album:(∥name.artist.labelNameFilter)
   returns all albums, then individually on each album, saves the album to the variable “name.” Then the query follows the artist property from the album followed by the labelNameFilter from all artist results. The labelNameFilter column only returns a result if a label of an artist has the same value as the “name” variable, here defined to be the album's name. Finally, the album is filtered from the final results based upon whether the labelNameFilter returned any results.

In this example, referring to the thread topology diagram 200 illustrated in FIG. 2, the column “labelNameFilter” may be parsed into a parse tree similar to:

```
Start
    BaseNodeOrigin
      Operator (‘.’)
          OperatorChild
            Union
                Property (‘label’)
                  Operator
                      Operator child
                        Filter
                            AdvancedFilter (‘:=’), (“(”) and (“)”)
                              BaseNodeOrigin
                                  Origins
                                    Nodes (“@name”)
```

Similarly, the query “album:(∥name.artist.labelNameFilter)” may be parsed into a parse tree similar to:

```
Start
    BaseNodeOrigin
      Origins
          Type (“album”)
      Operator
          OperatorChild
            Filter
                AdvancedFilter (“:”), (“(”) and (“)”)
                  Operator
                      OperatorChild
                        Label (“||”)
                            MapOrLabelValues (“name”)
                              Operator
                                  OperatorChild
                                    Union (“.”)
                                        Property (“artist”)
                                          Operator
                                              OperatorChild
                                                Union (“.”)
                                                    Property (“labelNameFilter”)
```

In these examples, strings following an operation are portions of the query consumed by the operation.

Complicated and processing-intensive Thread queries are possible to construct and execute. For example, columns and sub-queries are both executed independently on each element of a current result set during a Thread query execution. If one sub-query is nested within another sub-query, or if a sub-query calls a column, the inner sub-query or column may be called repeatedly in a loop. The repeated calls to the inner sub-query or column may be expensive from a processing standpoint. For this reason, caching is often used to store the results of a prior query for reuse if the query's execution is again requested. Instead of re-executing the query, the cached results are returned.

Thread also allows variable binding as a part of a query. For example, a current set of objects can be bound to a variable which can then be subsequently referenced to access the current set of objects. Within Thread, bound variables use the same syntax as an object reference, a unique ID. For example, in some implementations, the “@” symbol followed by an alphanumeric string can be used to indicate a bound variable and an object reference. In some implementations, if a variable is bound over an earlier variable, it replaces that variable. Further, if a bound variable's name conflicts with an object's unique ID, the object's unique ID takes precedence. In some implementations, unique IDs are numeric.

Caching the results of column evaluations may be advantageous from a processing standpoint. An issue arises, however, when a column references a bound variable. In this case, caching the data results of a column evaluation should be avoided because data referenced by the bound variable that is used in the evaluation of the column may change between the point the results of the column evaluation were last cached and a subsequent evaluation of the column. In this case, if cached data were used in the later evaluation of the column, the column evaluation would result in incorrect data. Therefore, it is necessary to determine whether a column refers to a bound variable and to avoid caching results of a column evaluation that refers to a bound variable.

For any given property operator as shown in the thread topology diagram 200, the data type that the property is applied to is not known in advance. Specifically, it is unknown whether the property refers to a column. To further complicate matters, in some implementations, columns can also refer to each other, and can also refer to objects by a unique ID. Thus, it is unclear in advance whether a unique ID reference in a column is to an object or to a bound variable. It is, therefore, necessary to also determine whether a column refers to another column and/or uses a unique ID reference in order to determine whether to cache results of a column evaluation.

In some implementations at least two caches are used. A first cache, a uses labels cache, is used to store whether columns in the database use labels as part of their execution. The uses labels cache persists between Thread queries until any column's definition is modified, in which case it is cleared for the column. In some implementations, the uses labels cache exists as a single cache per database. In some implementations, the use labels cache records one of three states for each column: 1) a column uses labels; 2) a column does not use labels; 3) a calculation has not been performed. In these implementations, the three states can be indicated through the use of Boolean or NULL values.

A second cache, a property results cache, is individually associated with each data object for the duration of an individual Thread query execution. When a data object property operation is followed, results of the property operation are stored in the second cache unless an existing value for that property operation already exists in the second cache, in which case the cached value may be used.

When evaluating a property operation on a data object, a determination is made as to whether the result of the property operation should be cached. A label is a thread operator that binds a variable. At Thread query execution time, a check is performed to determine if a column references what could be a bound variable by determining whether the column uses labels. An indication as to whether a column uses labels is stored in the uses labels cache, and, for performance reasons, the uses labels cache is maintained and populated on an as-needed basis. When the cache is queried for information on whether a column uses labels, if no information is available, an answer to the question is calculated on-the-fly.

Bound variables in any given query are not considered for caching for at least two reasons. First, a cache is independent of any specific Thread query and a specific Thread's query bindings are not universally relevant to all Thread queries. Second, currently bound variables do not necessarily predict similar property values in a future call to the property operation within the same Thread query.

In evaluating any column for caching potential, its parse tree is traversed and evaluated. In some implementations, each column is parsed independently from queries referring to it. For each property operation encountered in a parse tree, any columns that could be referenced by the property name of the property operation are also evaluated. Due to the use of duck typing, it is not certain at this point what type the property operation will be evaluated against. Each property operator in a query has a field name, so a column with the given field name is searched for in the current schema. If a unique ID reference is encountered within a given column or within referenced columns from a given column, the given column is not cached. Otherwise, the given column is cached. If a first column is modified, the uses labels cache is cleared for all columns at least because a second or other column's uses labels cache values may have been determined based upon the first column's uses labels cache values.

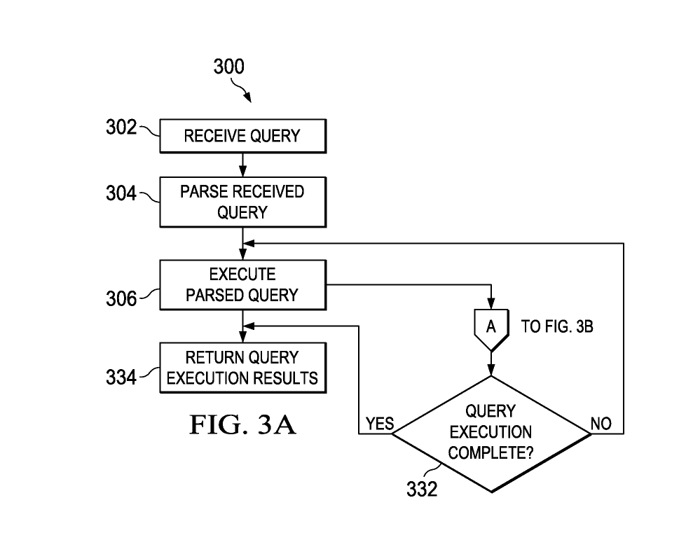

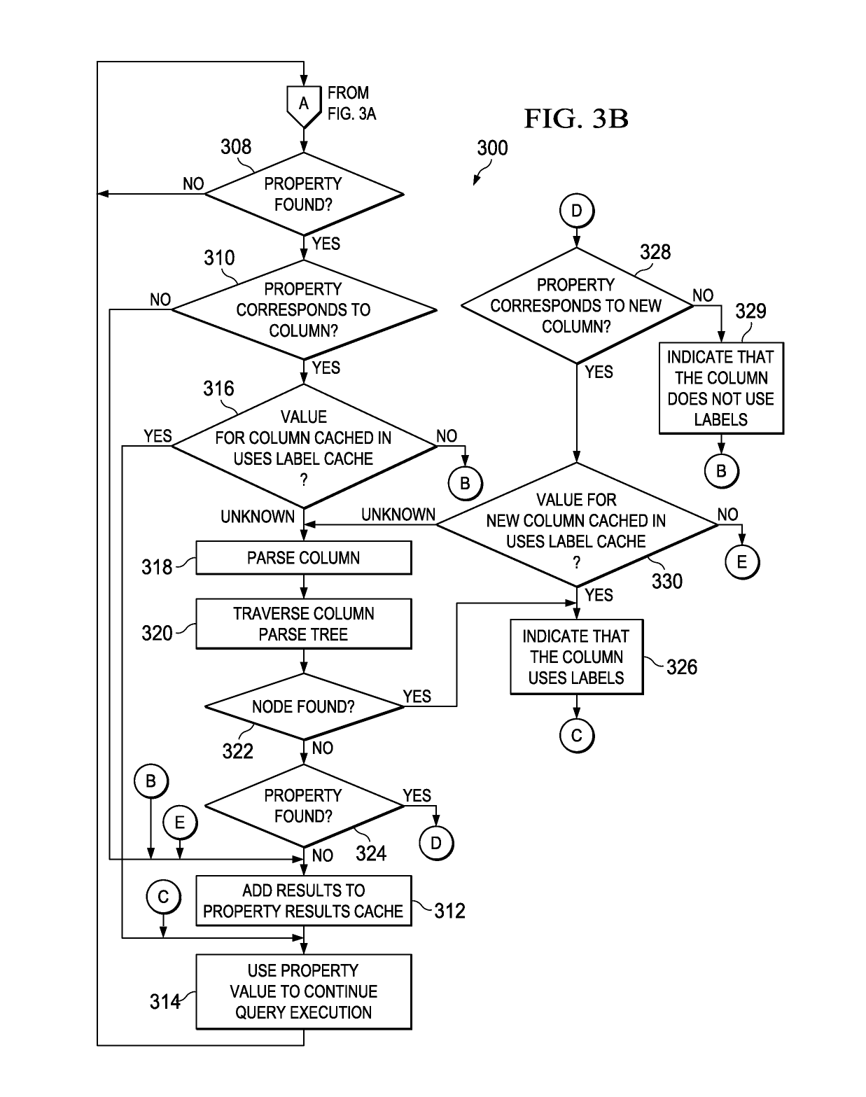

Turning now to FIGS. 3A-3B, FIGS. 3A-3B illustrate a method for calculating property caching exclusions in a graph evaluation query language. For clarity of presentation, the description that follows generally describes method 300 in the context of FIG. 1 and FIG. 2. However, it will be understood that method 300 may be performed, for example, by any other suitable system, environment, software, and hardware, or a combination of systems, environments, software, and hardware as appropriate.

Referring now to FIG. 3A, method 300 begins at 302. At 302, a Thread query is received. In some implementations, the Thread query is received as a plain text string. In other implementations, the Thread query can be received in any other suitable format. From 302, method 300 proceeds to 304.

At 304, the received Thread query is parsed into a parse tree as discussed above. In some implementations, the received Thread query is parsed into a parse tree. In some implementations the received Thread query is parsed into a parse tree consistent with the language of parse trees as described by the thread topology diagram illustrated in FIG. 2. From 304, method 300 proceeds to 306.

At 306, the parsed Thread query is executed. In some implementations, the parse tree for the query is traversed and each applicable operation in the parse tree is executed. Each operation consumes as input a set of data objects, the current result set, and passes the result of the operation, the subsequent result set, to the next operation. In some implementations, the current result set and the subsequent result set may be the same or different. From 306, method 300 proceeds to FIG. 3B.

Referring now to FIG. 3B, method 300 continues at 308. At 308, a determination is made whether a property operation has been encountered during the traversal of the parse tree. If at 308, it is determined that a property has not been encountered, the property operation is evaluated and the method 300 proceeds to 306 as illustrated in FIG. 3A. If at 308, however, it is determined that a property has been encountered, a determination as to whether the property value may be cached is performed. Method 300 proceeds to 310.

At 310, a determination is made whether a property operation field name corresponds to a column. For example, for the album-artist-label database schema described above, if we are working with an artist type “KingofRock” and the property operation field name corresponds to “firstLabel” (i.e., Property(“firstLabel”)), the artist type would be checked for an associated column named “firstlabel.” If at 310, it is determined that the property operation field name does not correspond to a column, the method 300 proceeds to 312. At 312, the property operation field name is added to the property results cache, which is stored with a data object associated with the Thread query. From 312, method 300 proceeds to 314. At 314, the property operation result value is used to continue the Thread query execution. If at 310, however, it is determined that the property operation field name does correspond to a column, the method 300 proceeds to 316.

At 316, a determination is made whether the column uses labels, for example data indicating whether the column uses labels could be retrieved from the uses labels cache. For example, if the uses labels cache has a TRUE value stored for the column in the uses labels state, the determination would be made that the column uses labels. However, if the uses labels cache has a TRUE value stored for the column in the does not use labels state, the determination would be made that the column does not use labels. Further, if the uses labels cache has a TRUE value stored for the column in the a calculation has not been performed state or no entry for the column exists, a determination would be made that whether the column uses labels is unknown. It will be appreciated that other values and/or methods of indication may be made in the uses labels cache in order to return similar results. If at 316, it is determined that the column does not use labels, the method 300 proceeds to 312. If at 316, however, is it determined that it is unknown whether a column uses labels, method 300 proceeds to 318. If at 316, however, it is determined that the column does use labels, the method 300 proceeds to 314. At 314, the result for the column is used to continue the Thread query execution.

At 318, the column is parsed as in 304 above and the column is evaluated to determine whether it uses labels. From 318, method 300 proceeds to 320.

At 320, Node and Property operations are searched for within the parse tree for the column. Note that the operations of the column's parse tree are not executed but are evaluated. For example, a property operation of Property(“firstLabel”) is not executed, but the value of “firstLabel” would be further examined as described below. From 320, method 300 proceeds to 322.

At 322, a determination is made whether a node operation is found in the parse tree for the column. For example, if “@name” is found, it would be determined that a node operation was found because a variable is being referenced. In this case, whether the variable is a bound variable or a unique ID reference is not determined. This is because the variable could be subsequently bound after property results are cached, an undesirable situation. If at 322, it is determined that a node operation is not found in the parse tree for the column, the method 300 proceeds to 324. If at 316, however, it is determined that a node operation is found in the parse tree for the column, the method 300 proceeds to 326. At 326, that the column uses labels is indicated within the uses labels cache. Note that finding a single node operation “short-circuits” the determination of whether the column uses labels and whether the property results cache may be populated. From 326, method 300 proceeds to 314.

At 324, a determination is made whether a property operation is found in the parse tree for the column. If at 324, it is determined that a property operation is not found in the parse tree for the column, the column is indicated in the uses labels cache as not using labels. The method 300 proceeds to 312. If at 324, however, it is determined that a property operation is found in the parse tree for the column, the method 300 proceeds to 328.

At 328, a determination is made whether the property value found in the parse tree for the column corresponds to a new column. If at 328, it is determined that the property value found in the parse tree for the column does not correspond to a new column, method 300 proceeds to 329. At 329, that the column does not use labels is indicated in the uses labels cache. The method 300 proceeds to 312. If at 328, however, it is determined that the property value found in the parse tree for the column corresponds to a new column, the method 300 proceeds to 330.

At 330, a determination is made whether the new column uses labels. As above at 316, data indicating whether the new column uses labels could be retrieved from the uses labels cache. If at 330, it is determined that the new column uses labels, the method 300 proceeds to 326. If at 330, it is determined that the new column does not use labels, the method 300 proceeds to 312. If at 330, however, it is determined that it is unknown whether the new column uses labels, method 300 proceeds to 318 to parse the new column. Note that multiple property operations may be found within a single column definition. Each property must be evaluated independently until either a node operator is found or all properties are exhausted. In some implementations, this further evaluation can be recursive. For example, if a third column is encountered that uses a label while evaluating a second column used by a first column, the uses label cache is populated to indicate a label is used for each column back to the first column up a recursive stack (i.e., the third, second, and first columns). In other implementations, the further evaluation can be performed by any other suitable processing method.

Returning to FIG. 3A, at 332, a determination is made whether the execution of each Thread query operation is complete. If at 332, it is determined that the execution of each Thread query operation is complete, the method 300 proceeds to 334 where the results of the Thread query execution are returned. After 334, method 300 stops. If at 332, however, it is determined that the execution of each Thread query operation is not complete, the method 330 proceeds to 306 to execute the next parsed Thread query operation.

Implementations of the subject matter and the functional operations described in this specification can be implemented in digital electronic circuitry, in tangibly-embodied computer program or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal (e.g., a machine-generated electrical, optical, or electromagnetic signal) that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, those based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Other implementations of the subject matter described in this specification can be implemented in a computing system that includes a back-end component, e.g., a data server, or that includes a middleware component, e.g., an application server, or that includes a front-end component, e.g., a client computer, or any combination of one or more such back-end, middleware, or front-end components. The components of the computing system can be interconnected by any form or medium of digital data communication, e.g., a communication network.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method, comprising:
determining whether a value of a query property operation corresponds to a named sub-query;
using a first cache to determine whether the named sub-query uses labels;
parsing the named sub-query into a first parse tree; and
evaluating, by operation of a computer, the parsed named sub-query using the first parse tree to determine whether the result for the named sub-query may be cached, the evaluation comprising:
determining whether a node operation is encountered in the named sub-query;
determining whether a value of a named sub-query property operation corresponds to a new named sub-query;
using a first cache to determine whether the new named sub-query uses labels;
parsing the new named sub-query into a second parse tree; and
evaluating the parsed new named sub-query using the second parse tree to determine whether the result for the new named sub-query may be cached.

2. The method of claim 1, further comprising adding the value of the query property operation to a second cache.

3. The method of claim 2, further comprising using the value of the query property operation to continue execution of the query.

4. The method of claim 1, further comprising indicating in the first cache that the named sub-query uses labels upon the determination that a node operation is encountered in the named sub-query.

5. The method of claim 4, further comprising indicating in the first cache that any ancestral query of the named sub-query uses labels.

6. The method of claim 1, further comprising adding the result of the parsed named sub-query to a second cache.

7. The method of claim 6, further comprising using the result of the parsed named sub-query to continue execution of the query.

8. The method of claim 1, further comprising indicating in the first cache that the named sub-query uses labels upon an indication in the first cache that the new named sub-query uses labels.

9. The method of claim 8, further comprising indicating in the first cache that any ancestral query of the new named sub-query uses labels.

10. A system, comprising:
at least one computer and at least one storage device storing instructions that are operable, when executed by the at least one computer, to cause the at least one computer to perform operations comprising:
determining whether a value of a query property operation corresponds to a named sub-query;
using a first cache to determine whether the named sub-query uses labels;
parsing the named sub-query into a first parse tree; and
evaluating the parsed named sub-query using the first parse tree to determine whether the result for the named sub-query may be cached, the evaluation comprising:
determining whether a node operation is encountered in the named sub-query;
determining whether a value of a named sub-query property operation corresponds to a new named sub-query;
using a first cache to determine whether the new named sub-query uses labels;
parsing the new named sub-query into a second parse tree; and
evaluating the parsed new named sub-query using the second parse tree to determine whether the result for the new named sub-query may be cached.

11. The system of claim 10, further comprising adding the value of the query property operation to a second cache.

12. The system of claim 11, further comprising using the value of the query property operation to continue execution of the query.

13. The system of claim 10, further comprising indicating in the first cache that the named sub-query uses labels upon the determination that a node operation is encountered in the named sub-query.

14. The system of claim 13, further comprising indicating in the first cache that any ancestral query of the named sub-query uses labels.

15. The system of claim 10, further comprising adding the result of the parsed named sub-query to a second cache.

16. The system of claim 15, further comprising using the result of the parsed named sub-query to continue execution of the query.

17. The system of claim 10, further comprising indicating in the first cache that the named sub-query uses labels upon an indication in the first cache that the new named sub-query uses labels.

18. The system of claim 17, further comprising indicating in the first cache that any ancestral query of the new named sub-query uses labels.
